(19) United States
(12) Patent Application Publication
(10) Pub. No.: US 2018/0224346 A1
(43) Pub. Date: Aug. 9, 2018

(54) SENSOR SHEET AND CAPACITANCE-TYPE SENSOR

(71) Applicant: Sumitomo Riko Company Limited, Aichi-ken (JP)

(72) Inventors: Junya KAWAGUCHI, Aichi-ken (JP); Hiroshi YAMADA, Aichi-ken (JP); Tomohiro FUJIKAWA, Aichi-ken (JP); Hikaru HAYASHI, Aichi-ken (JP)

(73) Assignee: Sumitomo Riko Company Limited, Aichi-ken (JP)

(21) Appl. No.: 15/941,399

(22) Filed: Mar. 30, 2018

Related U.S. Application Data
(63) Continuation of application No. PCT/JP2017/006815, filed on Feb. 23, 2017.

(30) Foreign Application Priority Data
Feb. 24, 2016 (JP) 2016-032868
Aug. 12, 2016 (JP) 2016-158536

(51) Int. Cl. G01L 9/12

(52) U.S. Cl. CPC G01L 9/12

(57) ABSTRACT

A sensor sheet and a capacitance-type sensor are provided in which the proportion of a dead area to the entire sensor body is small and detection units that are incapable of detection do not tend to be formed after being cut. A sensor sheet includes a pressure sensing area in which a plurality of detection units are set, and a dead area that is disposed adjacent to the pressure sensing area in a planar direction and that has a take-out portion. A front-side detection path that passes by way of front-side jumper wiring layers and a back-side detection path that passes by way of back-side jumper wiring layers are set between the detection units and the take-out portion. The sensor sheet is cuttable while securing a sensor body that has at least one detection unit, the take-out portion, and the front-side detection path and the back-side detection path for the detection unit.

### TECHNICAL FIELD

The present invention relates to a cuttable sensor sheet, and to a capacitance-type sensor that includes a sensor body acquired from the sensor sheet.

### BACKGROUND ART

FIG. 15 is a transparent top view of a capacitance-type sensor according to the related art (see Patent Document 1, for example). Members disposed on the back side with respect to a dielectric layer are indicated by the dotted lines. As illustrated in FIG. 15, a connector 106 is disposed at the front left corner of a capacitance-type sensor 100. Four front-side electrode layers 102 extend in the left-right direction. Four front-side wiring layers 103 couple the respective left ends of the four front-side electrode layers 102 and the connector 106 to each other. The front-side wiring layers 103 and the front-side electrode layers 102 are disposed side by side in the planar direction. Four back-side electrode layers 104 extend in the front-rear direction. Four back-side wiring layers 105 couple the respective front ends of the four back-side electrode layers 104 and the connector 106 to each other. The back-side wiring layers 105 and the back-side electrode layers 104 are disposed side by side in the planar direction.

The dielectric layer is interposed between: the front-side electrode layers 102 and the front-side wiring layers 103; and the back-side electrode layers 104 and the back-side wiring layers 105. As indicated by hatching in FIG. 15, a total of 16 detection units 107 are set at portions at which the four front-side electrode layers 102 and the four back-side electrode layers 104 overlap each other.

### PRIOR-ART DOCUMENTS

### Patent Documents

Patent Document 1: Japanese Patent Application Publication No. 2013-200229 (JP2013-200229 A)

### SUMMARY OF THE INVENTION

The shape, the area, etc. (hereinafter abbreviated as “shape etc.”) of the capacitance-type sensor 100 differ depending on the usage of the capacitance-type sensor 100 and the shape and the area of the location at which the sensor is disposed. Therefore, in the case where the capacitance-type sensor 100 is manufactured by screen printing, for example, it is necessary to design and fabricate a dedicated screen mask or the like in accordance with the shape etc. of the capacitance-type sensor 100.

Thus, the inventors conceived of a method of using a part of the capacitance-type sensor 100 cut away in accordance with the shape etc. of the capacitance-type sensor 100. FIG. 16 is a transparent top view of a capacitance-type sensor that has been cut away from the capacitance-type sensor illustrated in FIG. 15.

As indicated by dot-and-dash hatching in FIG. 16, in the case where a part of the capacitance-type sensor 100 is cut away and used, the proportion of a dead area 111 (an area in which the front-side electrode layers 102 and the back-side electrode layers 104 are not disposed) to the entire capacitance-type sensor 100 after being cut away may become larger.

In addition, at least one of the front-side electrode layers 102, the front-side wiring layers 103, the back-side electrode layers 104, and the back-side wiring layers 105 is occasionally cut, depending on the cut shape. Therefore, as indicated by dotted hatching in FIG. 16, there tend to be detection units 107 that are discontinuous from the connector 106, that is, detection units 107 that are incapable of detection. Similarly, there tend to be detection units 107 that are incapable of detection also in the case where the capacitance-type sensor 100 is slit (cut) and used, although a part of the capacitance-type sensor is not cut away.

Thus, it is an object of the present invention to provide a sensor sheet in which detection units that are incapable of detection do not tend to be formed after the sensor sheet is cut, and a capacitance-type sensor that includes a sensor body acquired from the sensor sheet.

### Means for Solving the Problem

In order to solve the above problem, the present invention provides a sensor sheet including: a pressure sensing area which has a dielectric layer, a front-side electrode layer disposed on a front side of the dielectric layer, and a back-side electrode layer disposed on a back side of the dielectric layer, and in which a plurality of detection units are set at portions at which the front-side electrode layer and the back-side electrode layer overlap each other as seen from the front side or the back side; and a dead area that is disposed adjacent to the pressure sensing area in a planar direction and that has a take-out portion that enables amounts of electricity related to capacitances of the plurality of detection units to be taken out from an outside. The sensor sheet is characterized by including: a front-side insulating layer that is disposed on the front side of the front-side electrode layer and that has a front-side through hole that penetrates the front-side insulating layer in a front-back direction; a back-side insulating layer that is disposed on the back side of the back-side electrode layer and that has a back-side through hole that penetrates the back-side insulating layer in the front-back direction; a front-side jumper wiring layer that is disposed on the front side of the front-side insulating layer and that electrically connects between the front-side electrode layer and the take-out portion via the front-side through hole; and a back-side jumper wiring layer that is disposed on the back side of the back-side insulating layer and that electrically connects between the back-side electrode layer and the take-out portion via the back-side through hole, wherein a front-side detection path that passes by way of at least the front-side jumper wiring layer and a back-side detection path that passes by way of at least the back-side jumper wiring layer are set between each of the plurality of detection units and the take-out portion; and the sensor sheet is cuttable while securing a sensor body that has at least one of the detection units, the take-out portion, and the front-side detection path and the back-side detection path for the detection unit.

Here, the term “cut” includes an “aspect in which a sensor body is cut away (cut apart) from a sensor sheet”. That is, the term includes an aspect in which the area of the sensor body after being cut is smaller than the area of the sensor sheet before being cut. The term “cut” also includes an “aspect in which a slit is formed in a sensor sheet (a sensor body is not cut away (cut apart) from the sensor sheet)”. That is, the term includes an aspect in which the area of the sensor sheet before being cut is equal to the area of the sensor body after being cut.

The present invention also provides a capacitance-type sensor including the sensor body and a control unit electrically connected to the take-out portion.

### Effects of the Invention

The sensor body includes at least one detection unit, the take-out portion, and the front-side detection path and the back-side detection path for the detection unit. Therefore, a sensor body, that is, a capacitance-type sensor, of any shape etc. can be acquired from a sensor sheet of a predetermined shape etc. Thus, it is not necessary to design and fabricate a member exclusively for the capacitance-type sensor (such as a plate for printing for a case where the capacitance-type sensor is fabricated by printing, or a die for molding for a case where the capacitance-type sensor is fabricated by molding, for example) one by one in accordance with the shape etc. of the desired capacitance-type sensor, even in the case of need for a plurality of capacitance-type sensors of different shapes etc. That is, it is only necessary to cut the sensor sheet in accordance with the shape etc. of the desired capacitance-type sensor. For example, it is only necessary to cut away the sensor body from the sensor sheet. Alternatively, it is only necessary to form a slit in the sensor sheet. Therefore, the manufacturing cost of the capacitance-type sensor can be reduced. The manufacturing cost can be reduced particularly in the case where small quantities of a large number of different models of the capacitance-type sensor are to be manufactured or in the case where prototypes of the capacitance-type sensor are to be manufactured.

In the sensor sheet according to the present invention, in addition, the front-side jumper wiring layer is connected to the front-side electrode layer from the front side via the front-side through hole. Similarly, the back-side jumper wiring layer is connected to the back-side electrode layer from the back side via the back-side through hole. Therefore, the detection units that are incapable of detection do not tend to be formed in the sensor body after being cut (e.g. after being cut away or after a slit is formed). Thus, the degree of freedom in cut shape of the sensor body (e.g. the cut shape or the slit shape) can be enhanced.

In the sensor sheet according to the present invention, in addition, the front-side jumper wiring layer and the front-side electrode layer can be disposed so as to overlap each other in the front-back direction with the front-side insulating layer interposed therebetween. Similarly, the back-side jumper wiring layer and the back-side electrode layer can be disposed so as to overlap each other in the front-back direction with the back-side insulating layer interposed therebetween. Therefore, the proportion of the dead area to the entire sensor sheet can be reduced. That is, the proportion of the dead area to the entire sensor body after being cut away can be reduced.

In addition, with the capacitance-type sensor according to the present invention, the amount of electricity related to the capacitance of the detection unit can be transmitted to the control unit from the take-out portion of the sensor body which is acquired from the sensor sheet. In addition, in the case where the sensor body has the detection unit which has been partially cut away, for example, the control unit can correct the amount of electricity related to the capacitance of the detection unit which has been partially cut away. Therefore, the detection precision of the capacitance-type sensor can be enhanced.

### BRIEF DESCRIPTION OF THE DRAWINGS

FIG. 1 is a transparent top view of a sensor sheet according to a first embodiment.

FIG. 2 is a sectional view taken along the II-II direction of FIG. 1.

FIG. 3 is an exploded perspective view of a front-side electrode unit of the sensor sheet.

FIG. 4 is an exploded perspective view of a back-side electrode unit of the sensor sheet.

FIGS. 5A to 5D are each a transparent top view of a capacitance-type sensor that includes a sensor body (first to fourth) that has been cut away from the sensor sheet illustrated in FIG. 1.

FIG. 6 is a transparent top view of a sensor sheet according to a second embodiment.

FIG. 7 is a transparent top view of a sensor sheet according to a third embodiment.

FIG. 8 is an enlarged view of the box VIII of FIG. 7.

FIGS. 9A and 9B are each a transparent top view of a capacitance-type sensor that includes a sensor body (first and second) cut away from the sensor sheet illustrated in FIG. 7.

FIG. 10 is a transparent top view of a sensor sheet according to a fourth embodiment.

FIG. 11 is a transparent top view of a front-side electrode unit of the sensor sheet.

FIG. 12 is a transparent top view of a back-side electrode unit of the sensor sheet.

FIG. 13 illustrates the arrangement of a capacitance-type sensor according to the fourth embodiment.

FIG. 14 is a transparent top view of a sensor sheet according to another embodiment.

FIG. 15 is a transparent top view of a capacitance-type sensor according to the related art.

FIG. 16 is a transparent top view of a capacitance-type sensor that has been cut away from the capacitance-type sensor illustrated in FIG. 15.

### MODES FOR CARRYING OUT THE INVENTION

A sensor sheet and a capacitance-type sensor according to an embodiment of the present invention will be described below. The upper side and the lower side in the drawings correspond to the “front side” and the “back side”, respectively, according to the present invention. In addition, at least one of the front-rear direction and the left-right direction correspond to the “planar direction” according to the present invention.

### First Embodiment

### [Configuration of Sensor Sheet]

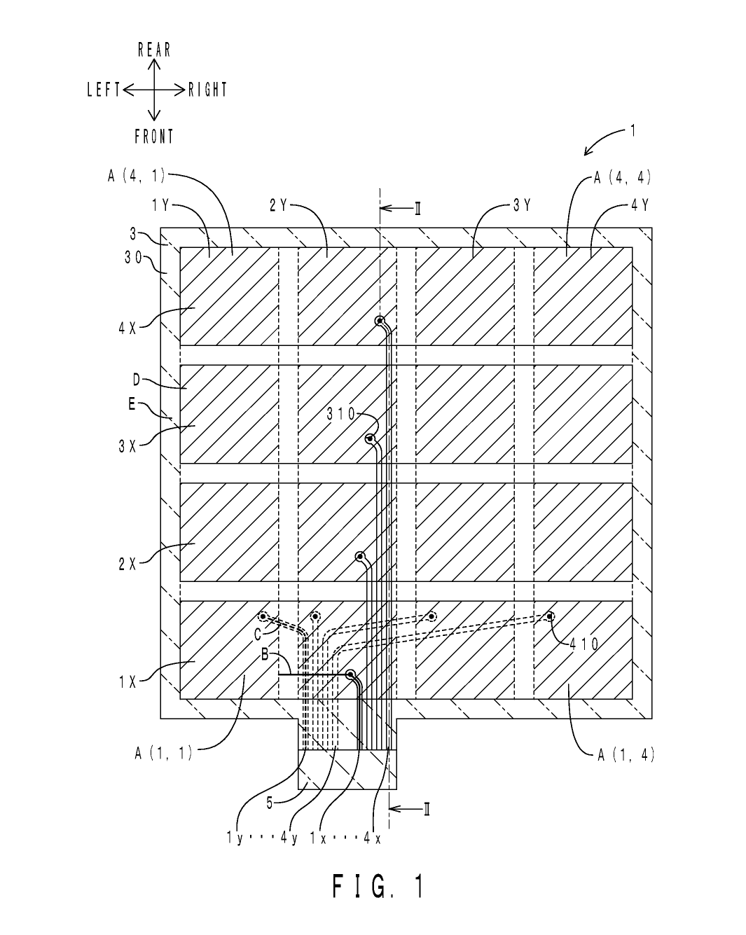

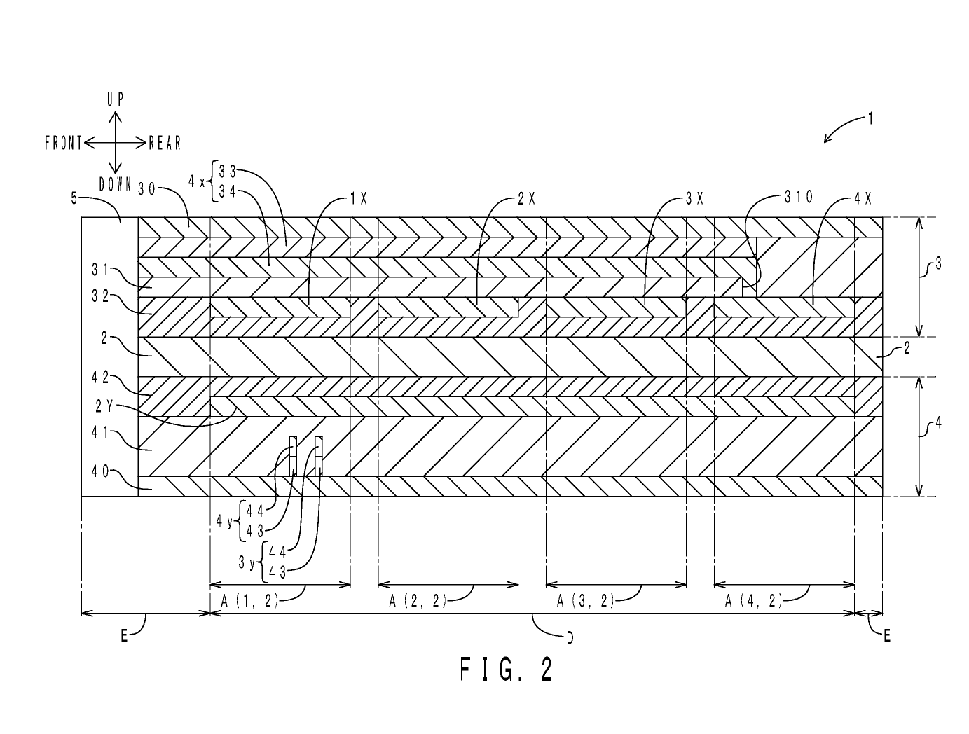

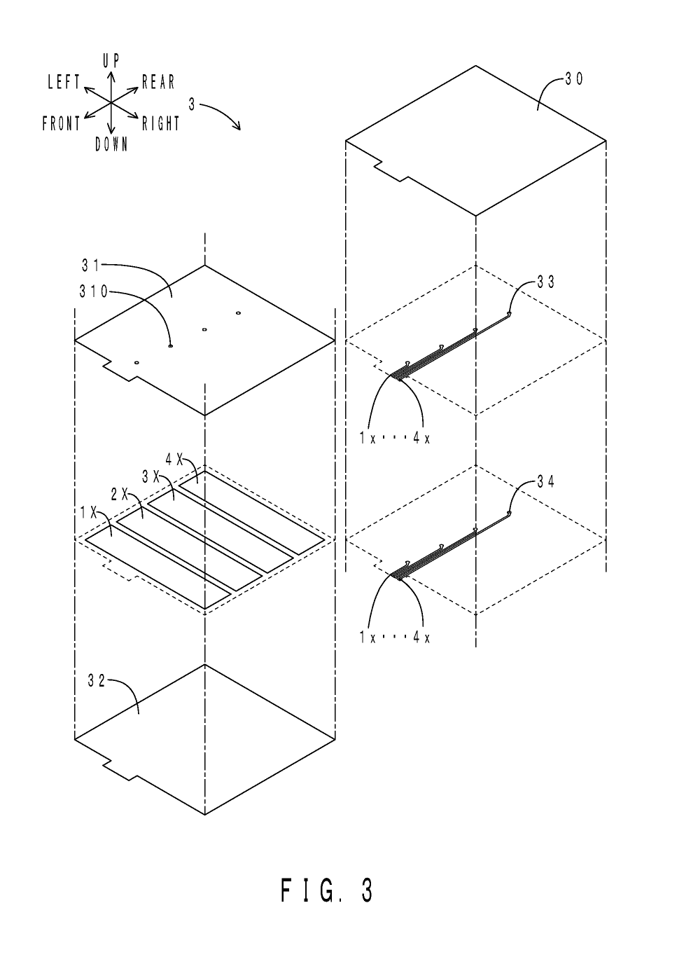

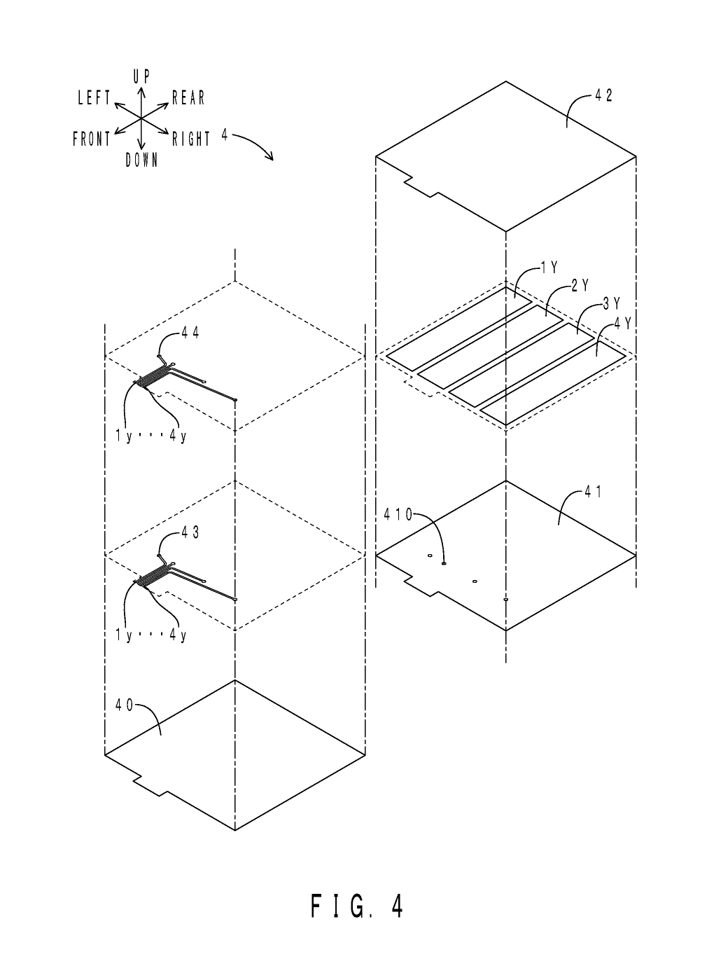

First, the configuration of the sensor sheet according to the present embodiment will be described. FIG. 1 is a transparent top view of the sensor sheet according to the present embodiment. FIG. 2 is a sectional view taken along the II-II direction of FIG. 1. FIG. 3 is an exploded perspective view of a front-side electrode unit of the sensor sheet. FIG. 4 is an exploded perspective view of a back-side electrode unit of the sensor sheet. In FIG. 1, the back-side electrode unit is indicated by the dotted lines.

As illustrated in FIGS. 1 to 4, a sensor sheet 1 includes a dielectric layer 2, a front-side electrode unit 3, a back-side electrode unit 4, and a connector 5. The connector 5 is included in the concept of the “take-out portion” according to the present invention.

(Dielectric Layer 2 and Front-Side Electrode Unit 3)

The dielectric layer 2 is made of urethane foam, and has a sheet shape. As illustrated in FIG. 2, the front-side electrode unit 3 is disposed on the front side of the dielectric layer 2. As illustrated in FIG. 3, the front-side electrode unit 3 includes a front-side substrate 30, four front-side jumper wiring layers 1x to 4x, a front-side insulating layer 31, four front-side electrode layers 1X to 4X, and a front-side protection layer 32.

The front-side substrate 30 is made of polyethylene terephthalate (PET), and has a sheet shape. As illustrated in FIG. 3, the front-side jumper wiring layers 1x to 4x, the front-side insulating layer 31, the front-side electrode layers 1X to 4X, and the front-side protection layer 32 are disposed on the lower side of the front-side substrate 30, sequentially from the upper side toward the lower side.

The front-side insulating layer 31 has a sheet shape. The front-side insulating layer 31 contains urethane rubber and titanium oxide particles that serve as an anti-blocking agent. As illustrated in FIG. 3, four front-side through holes 310 are provided in the front-side insulating layer 31. The four front-side through holes 310 and the four front-side electrode layers 1X to 4X face each other in the up-down direction. As illustrated in FIG. 1, the four front-side through holes 310 are arranged in the front-rear direction so as to overlap the back-side electrode layer 2Y that is the second from the left side (the back-side electrode layer that is the closest to the connector 5) as seen from the upper side.

As illustrated in FIG. 3, the four front-side jumper wiring layers 1x to 4x are disposed on the upper surface of front-side insulating layer 31. The front-side jumper wiring layers 1x to 4x each include a first wiring layer 33 and a second wiring layer 34. The first wiring layer 33 is formed on the lower surface of the front-side substrate 30. The first wiring layer 33 contains acrylic rubber and silver powder. The second wiring layer 34 is formed on the lower surface of the first wiring layer 33. The second wiring layer 34 contains acrylic rubber and conductive carbon black.

The four front-side electrode layers 1X to 4X are disposed on the lower surface of the front-side insulating layer 31. The front-side electrode layers 1X to 4X each contain acrylic rubber and conductive carbon black. The front-side electrode layers 1X to 4X each have the shape of a band that extends in the left-right direction. The front-side electrode layers 1X to 4X are spaced from each other in the front-rear direction via a predetermined clearance, and disposed in parallel with each other.

The front-side jumper wiring layers 1x to 4x and the front-side electrode layers 1X to 4X are electrically connected to each other via the front-side through holes 310. Particularly, the front-side jumper wiring layer 1x, the front-side jumper wiring layer 2x, the front-side jumper wiring layer 3x, and the front-side jumper wiring layer 4x are electrically connected to the front-side electrode layer 1X, the front-side electrode layer 2X, the front-side electrode layer 3X, and the front-side electrode layer 4X, respectively. As indicated by the black dots in FIG. 1, front-side contact points (contact points between the front-side jumper wiring layers 1x to 4x and the front-side electrode layers 1X to 4X) are disposed radially inward of the front-side through holes 310 as seen from the upper side.

As illustrated in FIG. 2, the front-side protection layer 32 is disposed on the upper surface of the dielectric layer 2. The front-side protection layer 32 covers the front-side electrode layers 1X to 4X and the front-side insulating layer 31 from the lower side. The front-side protection layer 32 is made of urethane rubber, and has a sheet shape.

(Back-Side Electrode Unit 4)

As illustrated in FIG. 2, the back-side electrode unit 4 is disposed on the lower side of the dielectric layer 2. The configuration of the back-side electrode unit 4 is the same as the configuration of the front-side electrode unit 3. That is, as illustrated in FIG. 4, the back-side electrode unit 4 includes a back-side substrate 40, four back-side jumper wiring layers 1y to 4y, a back-side insulating layer 41, four back-side electrode layers 1Y to 4Y, and a back-side protection layer 42.

The back-side substrate 40 and the front-side substrate 30, the back-side jumper wiring layers 1y to 4y and the front-side jumper wiring layers 1x to 4x, the back-side insulating layer 41 and the front-side insulating layer 31, the back-side electrode layers 1Y to 4Y and the front-side electrode layers 1X to 4X, and the back-side protection layer 42 and the front-side protection layer 32 are of the same material as each other.

As illustrated in FIGS. 3 and 4, the stacking structure (arrangement in the up-down direction) of the back-side electrode unit 4 is symmetric with the stacking structure of the front-side electrode unit 3 in the up-down direction. That is, as illustrated in FIG. 4, the back-side jumper wiring layers 1y to 4y, the back-side insulating layer 41, the back-side electrode layers 1Y to 4Y, and the back-side protection layer 42 are disposed on the upper side of the back-side substrate 40, sequentially from the lower side toward the upper side.

As illustrated in FIG. 4, four back-side through holes 410 are provided in the back-side insulating layer 41. The four back-side through holes 410 and the four back-side electrode layers 1Y to 4Y face each other in the up-down direction. As illustrated in FIG. 1, the four back-side through holes 410 are arranged in the left-right direction so as to overlap the front-side electrode layer 1X that is the first from the front side (the front-side electrode layer that is the closest to the connector 5) as seen from the upper side.

As illustrated in FIG. 4, the back-side jumper wiring layers 1y to 4y each include a first wiring layer 43 and a second wiring layer 44. The back-side electrode layers 1Y to 4Y each have the shape of a band that extends in the front-rear direction. The back-side electrode layers 1Y to 4Y are spaced from each other in the left-right direction via a predetermined clearance, and disposed in parallel with each other.

The back-side jumper wiring layers 1y to 4y and the back-side electrode layers 1Y to 4Y are electrically connected to each other via the back-side through holes 410. Particularly, the back-side jumper wiring layer 1y, the back-side jumper wiring layer 2y, the back-side jumper wiring layer 3y, and the back-side jumper wiring layer 4y are electrically connected to the back-side electrode layer 1Y, the back-side electrode layer 2Y, the back-side electrode layer 3Y, and the back-side electrode layer 4Y, respectively. As indicated by the black dots in FIG. 1, back-side contact points (contact points between the back-side jumper wiring layers 1y to 4y and the back-side electrode layers 1Y to 4Y) are disposed radially inward of the back-side through holes 410 as seen from the upper side.

(Connector 5)

As illustrated in FIG. 1, the connector 5 is disposed on the front side of the sensor sheet 1. The front-side jumper wiring layers 1x to 4x and the back-side jumper wiring layers 1y to 4y are electrically connected to the connector 5 with the front-side jumper wiring layers 1x to 4x and the back-side jumper wiring layers 1y to 4y insulated from each other.

[Detection Unit, Front-Side Detection Path, and Back-Side Detection Path]

As illustrated in FIG. 1, the front-side electrode layers 1X to 4X and the back-side electrode layers 1Y to 4Y are arranged in a grid pattern as seen from the upper side. As indicated by hatching in FIG. 1, a total of 16 detection units A (1, 1) to A (4, 4) are set at portions at which the front-side electrode layers 1X to 4X and the back-side electrode layers 1Y to 4Y overlap each other. For the detection units A (◯, Δ), “◯” corresponds to the front-side electrode layers 1X to 4X, and “Δ” corresponds to the back-side electrode layers 1Y to 4Y.

A front-side detection path is set between any of the detection units A (1, 1) to A (4, 4) and the connector 5. The front-side detection path passes by way of at least the front-side jumper wiring layers 1x to 4x. For example, as indicated by the thick solid line in FIG. 1, a front-side detection path B that passes by way of a part of the front-side electrode layer 1X and the front-side jumper wiring layer 1x is set between the detection unit A (1, 1) and the connector 5.

Similarly, a back-side detection path is set between any of the detection units A (1, 1) to A (4, 4) and the connector 5. The back-side detection path passes by way of at least the back-side jumper wiring layers 1y to 4y. For example, as indicated by the thick dotted line in FIG. 1, a back-side detection path C that passes by way of only the back-side jumper wiring layer 1y is set between the detection unit A (1, 1) and the connector 5.

(Pressure Sensing Area and Dead Area)

An area in which the front-side electrode layers 1X to 4X and the back-side electrode layers 1Y to 4Y are disposed (an area in which the detection units A (1, 1) to A (4, 4) are disposed) is a pressure sensing area D in which a load is detectable. Meanwhile, as indicated by dot-and-dash hatching in FIG. 1, an area in which the front-side electrode layers 1X to 4X and the back-side electrode layers 1Y to 4Y are not disposed (an area in which the connector 5, part of the front-side jumper wiring layers 1x to 4x, and part of the back-side jumper wiring layers 1y to 4y are disposed) is a dead area E in which a load is not detectable. The dead area E surrounds the pressure sensing area D like a frame from the outer side in the planar direction (directions that are orthogonal to the up-down direction).

[Configuration of Capacitance-Type Sensor]

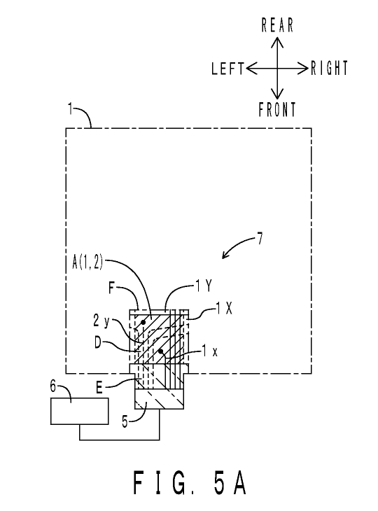

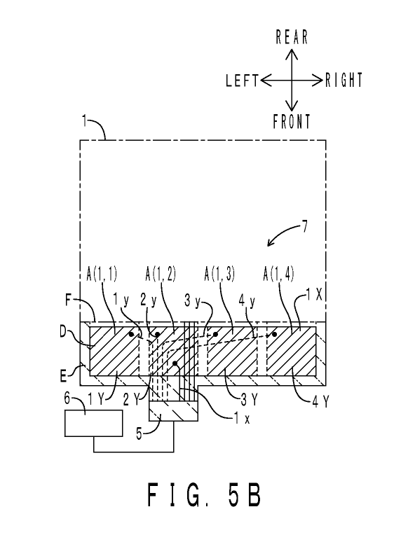

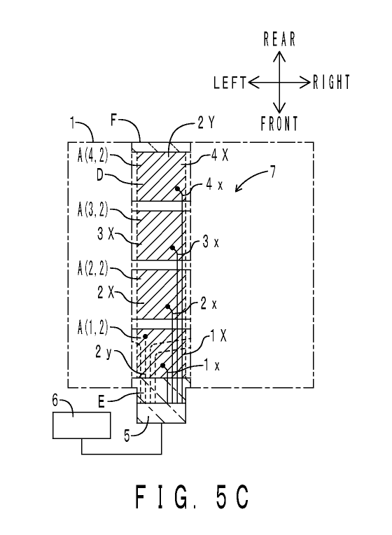

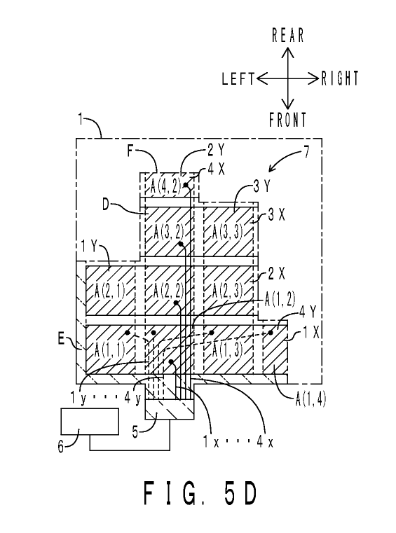

Next, the configuration of the capacitance-type sensor according to the present embodiment will be described. FIGS. 5A to 5D are each a transparent top view of a capacitance-type sensor that includes a sensor body (first to fourth) that has been cut away from the sensor sheet illustrated in FIG. 1. The front-side jumper wiring layers 1x to 4x and the front-side electrode layers 1X to 4X are indicated by the solid lines. The back-side jumper wiring layers 1y to 4y and the back-side electrode layers 1Y to 4Y are indicated by the dotted lines. The front-side contact points and the back-side contact points are indicated by the black dots. As illustrated in FIGS. 5A to 5D, a sensor body F is the sensor sheet 1 which includes a cutaway portion (a portion surrounded by the dot-and-dash line). The area of the sensor body F after being cut is smaller than the area of the sensor sheet 1 before being cut.

As illustrated in FIG. 5A, a capacitance-type sensor 7 includes the sensor body F in a small quadrangular shape which has been cut away from the sensor sheet 1, and a control unit 6. The sensor body F includes the detection unit A (1, 2), the connector 5, and the front-side detection path and the back-side detection path for the detection unit A (1, 2). The control unit 6 is electrically connected to the connector 5. The control unit 6 measures the load distribution in the pressure sensing area D.

The front-side detection path for the detection unit A (1, 2) passes by way of only the front-side jumper wiring layer 1x. The back-side detection path for the detection unit A (1, 2) passes by way of only the back-side jumper wiring layer 2y.

As illustrated in FIG. 5B, the capacitance-type sensor 7 includes the sensor body F in a band shape which has been cut away from the sensor sheet 1, and the control unit 6. The sensor body F includes the detection units A (1, 1) to A (1, 4), the connector 5, and the front-side detection paths and the back-side detection paths for the detection units A (1, 1) to A (1, 4).

The front-side detection path for the detection unit A (1, 1) passes by way of a part of the front-side electrode layer 1X and the front-side jumper wiring layer 1x. The back-side detection path for the detection unit A (1, 1) passes by way of only the back-side jumper wiring layer 1y. The front-side detection path and the back-side detection path for the detection unit A (1, 2) are as illustrated in FIG. 5A. The front-side detection path for the detection unit A (1, 3) passes by way of a part of the front-side electrode layer 1x and the front-side jumper wiring layer 1x. The back-side detection path for the detection unit A (1, 3) passes by way of only the back-side jumper wiring layer 3y. The front-side detection path for the detection unit A (1, 4) passes by way of a part of the front-side electrode layer 1X and the front-side jumper wiring layer 1x. The back-side detection path for the detection unit A (1, 4) passes by way of only the back-side jumper wiring layer 4y.

As illustrated in FIG. 5C, the capacitance-type sensor 7 includes the sensor body F in a band shape which has been cut away from the sensor sheet 1, and the control unit 6. The sensor body F includes the detection units A (1, 2) to A (4, 2), the connector 5, and the front-side detection paths and the back-side detection paths for the detection units A (1, 2) to A (4, 2). The front-side detection path and the back-side detection path for the detection unit A (1, 2) are as illustrated in FIG. 5A. The front-side detection path for the detection unit A (2, 2) passes by way of only the front-side jumper wiring layer 2x. The back-side detection path for the detection unit A (2, 2) passes by way of a part of the back-side electrode layer 2Y and the back-side jumper wiring layer 2y. The front-side detection path for the detection unit A (3, 2) passes by way of only the front-side jumper wiring layer 3x. The back-side detection path for the detection unit A (3, 2) passes by way of a part of the back-side electrode layer 2Y and the back-side jumper wiring layer 2y. The front-side detection path for the detection unit A (4, 2) passes by way of only the front-side jumper wiring layer 4x. The back-side detection path for the detection unit A (4, 2) passes by way of a part of the back-side electrode layer 2Y and the back-side jumper wiring layer 2y.

As illustrated in FIG. 5D, the capacitance-type sensor 7 includes the sensor body F in a staircase shape which has been cut away from the sensor sheet 1, and the control unit 6. The sensor body F includes the detection units A (1, 1) to A (1, 4), A (2, 1) to A (2, 3), A (3, 2), A (3, 3), and A (4, 2), the connector 5, and the front-side detection paths and the back-side detection paths for the detection units A (1, 1) to A (1, 4), A (2, 1) to A (2, 3), A (3, 2), A (3, 3), and A (4, 2). The front-side detection paths and the back-side detection paths for the detection units A (1, 1) to A (1, 4) are as illustrated in FIG. 5B. The front-side detection paths and the back-side detection paths for the detection units A (2, 2), A (3, 2), and A (4, 2) are as illustrated in FIG. 5C. The front-side detection path for the detection unit A (2, 1) passes by way of a part of the front-side electrode layer 2X and the front-side jumper wiring layer 2x. The back-side detection path for the detection unit A (2, 1) passes by way of a part of the back-side electrode layer 1Y and the back-side jumper wiring layer 1y. The front-side detection path for the detection unit A (2, 3) passes by way of a part of the front-side electrode layer 2X and the front-side jumper wiring layer 2x. The back-side detection path for the detection unit A (2, 3) passes by way of a part of the back-side electrode layer 3Y and the back-side jumper wiring layer 3y. The front-side detection path for the detection unit A (3, 3) passes by way of a part of the front-side electrode layer 3X and the front-side jumper wiring layer 3x. The back-side detection path for the detection unit A (3, 3) passes by way of a part of the back-side electrode layer 3Y and the back-side jumper wiring layer 3y.

The detection units A (1, 4) and A (4, 2) have been partially cut away. The control unit 6 corrects the amount of electricity (such as a voltage or a current, for example) related to the capacitance of the detection unit (1, 4) in accordance with the electrode area in a part of the front-side electrode layer 1X and a part of the back-side electrode layer 4Y that constitute the detection unit A (1, 4). Similarly, the control unit 6 corrects the amount of electricity related to the capacitance of the detection unit (4, 2) in accordance with the electrode area in a part of the front-side electrode layer 4X and a part of the back-side electrode layer 2Y that constitute the detection unit A (4, 2).

[Operation of Capacitance-Type Sensor]

Next, operation of the capacitance-type sensor according to the present embodiment will be described with reference to FIG. 5B. First, before a load is applied to the sensor body F (initial state), a voltage is applied to the front-side electrode layer 1X and the back-side electrode layers 1Y to 4Y, and a capacitance is calculated for each of the detection units A (1, 1) to A (1, 4). Subsequently, a capacitance is calculated for each of the detection units A (1, 1) to A (1, 4) in the same manner also after a load is applied to the sensor body F. In the detection units A (1, 1) to A (1, 4) to which a load is applied, the distance (electrode distance) between the front-side electrode layer 1X and the back-side electrode layers 1Y to 4Y becomes shorter. Therefore, the capacitance of the detection units A (1, 1) to A (1, 4) becomes larger. The control unit 6 detects a load for each of the detection units A (1, 1) to A (1, 4) on the basis of the amount of variation in capacitance. That is, the control unit 6 measures the load distribution in the pressure sensing area D.

[Function and Effect]

Next, the function and effect of the sensor sheet and the capacitance-type sensor according to the present embodiment will be described. As illustrated in FIGS. 5A to 5D, the sensor body F includes at least one detection unit A (1, 1) to A (4, 4), the connector 5, and the front-side detection path B and the back-side detection path C (see FIG. 1) for the detection unit A (1, 4) to A (4, 4). Therefore, the sensor body F, that is, the capacitance-type sensor 7, of any shape can be cut away from the sensor sheet 1 of a predetermined shape etc. (of a common, regular shape). Thus, it is not necessary to design and fabricate a member exclusively for the capacitance-type sensor 7 (such as a plate for printing for a case where the capacitance-type sensor 7 is fabricated by printing, or a die for molding for a case where the capacitance-type sensor 7 is fabricated by molding, for example) one by one in accordance with the shape etc. of the desired capacitance-type sensor 7, even in the case of need for a plurality of capacitance-type sensors 7 of different shapes etc. That is, it is only necessary to cut away the sensor body F from the sensor sheet 1 in accordance with the shape etc. of the desired capacitance-type sensor 7. Therefore, the manufacturing cost of the capacitance-type sensor 7 can be reduced. The manufacturing cost can be reduced particularly in the case where small quantities of a large number of different models of the capacitance-type sensor 7 are to be manufactured or in the case where prototypes of the capacitance-type sensor 7 are to be manufactured.

In addition, in the sensor sheet 1 according to the present embodiment, as illustrated in FIGS. 1 to 4, the front-side jumper wiring layers 1x to 4x are connected to the front-side electrode layers 1X to 4X from the upper side via the front-side through holes 310. Similarly, the back-side jumper wiring layers 1y to 4y are connected to the back-side electrode layers 1Y to 4Y from the lower side via the back-side through holes 410. Therefore, as illustrated in FIGS. 5A to 5D, the detection units A (1, 1) to A (4, 4) that are incapable of detection do not tend to be formed in the sensor body F after being cut away. Thus, the degree of freedom in cut shape of the sensor body F can be enhanced.

In addition, in the sensor sheet 1 according to the present embodiment, as illustrated in FIGS. 2 to 4, the front-side jumper wiring layers 1x to 4x and the front-side electrode layers 1X to 4X can be disposed so as to overlap each other in the up-down direction with the front-side insulating layer 31 interposed therebetween. Similarly, the back-side jumper wiring layers 1y to 4y and the back-side electrode layers 1Y to 4Y can be disposed so as to overlap each other in the up-down direction with the back-side insulating layer 41 interposed therebetween. Therefore, as illustrated in FIG. 1, the proportion (proportion in area) of the dead area E to the entire sensor sheet 1 can be reduced. That is, as illustrated in FIGS. 5A to 5D, the proportion of the dead area E to the entire sensor body F after being cut away can be reduced.

In addition, as indicated by the black dots in FIG. 1, the four back-side contact points are disposed so as to overlap the front-side electrode layer 1X, which is the closest to the connector 5, as seen from the upper side. Additionally, the four front-side contact points are disposed so as to overlap the back-side electrode layer 2Y, which is the closest to the connector 5, as seen from the upper side. Therefore, the front-side jumper wiring layers 1x to 4x and the back-side jumper wiring layers 1y to 4y can be disposed in proximity to the connector 5. Thus, as illustrated in FIGS. 5A to 5D, the front-side jumper wiring layers 1x to 4x and the back-side jumper wiring layers 1y to 4y are less likely to be cut when the sensor body F is cut away. Hence, the degree of freedom in cut shape of the sensor body F can be enhanced.

In addition, as illustrated in FIG. 5D, with the capacitance-type sensor 7 according to the present embodiment, the control unit 6 can correct the amounts of electricity related to the capacitances of the detection units A (1, 4) and A (4, 2) in the case where the sensor body F after being cut away has the detection units A (1, 4) and A (4, 2) which have been partially cut away. Therefore, the precision in detecting the load distribution can be enhanced.

In addition, the dielectric layer 2 is made of urethane foam. The front-side substrate 30 and the back-side substrate 40 are made of PET. The front-side insulating layer 31 and the back-side insulating layer 41 contain urethane rubber. The front-side jumper wiring layers 1x to 4x, the back-side jumper wiring layers 1y to 4y, the front-side electrode layers 1X to 4X, and the back-side electrode layers 1Y to 4Y contain acrylic rubber. The front-side protection layer 32 and the back-side protection layer 42 are made of urethane rubber. In this way, members that constitute the sensor sheet 1 can be manufactured using foam, an elastomer, or a material that contains an elastomer as a base material. Therefore, the sensor sheet 1 is flexible. Thus, the sensor sheet 1 can be cut easily using an edged tool (such as a cutter and scissors).

### Second Embodiment

The sensor sheet according to the present embodiment differs from the sensor sheet according to the first embodiment in that front-side contact points and back-side contact points are disposed individually in all the detection units. Only such a difference will be described below.

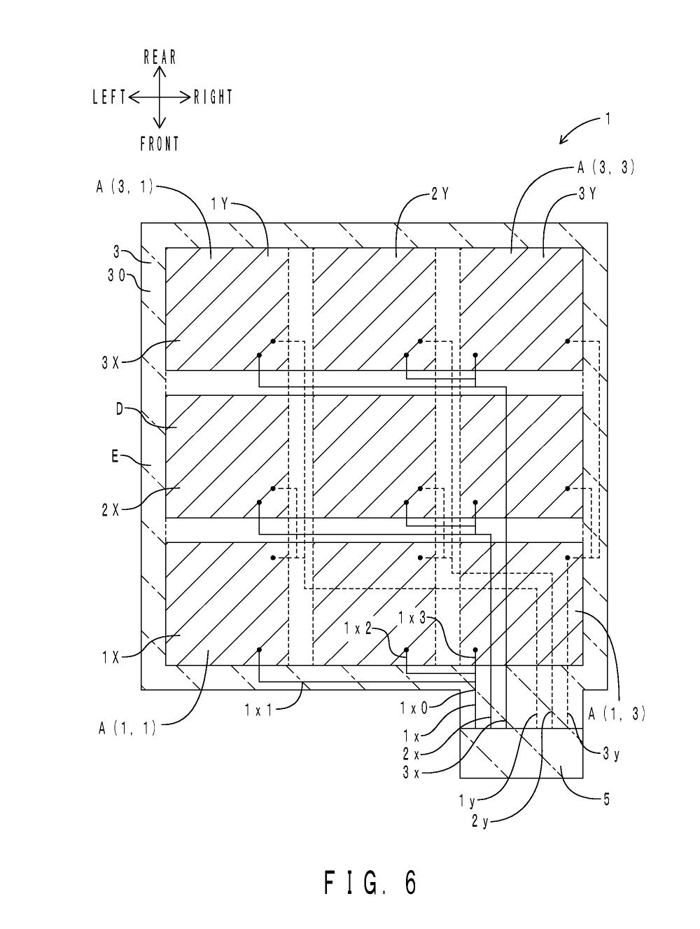

FIG. 6 is a transparent top view of the sensor sheet according to the present embodiment. Members corresponding to those in FIG. 1 are denoted by the same reference numerals. In addition, the front-side electrode layers 1X to 3X and the front-side jumper wiring layers 1x to 3x are indicated by the solid lines. The back-side electrode layers 1Y to 3Y and the back-side jumper wiring layers 1y to 3y are indicated by the dotted lines. The front-side contact points and the back-side contact points are indicated by the black dots.

As illustrated in FIG. 6, the front-side jumper wiring layer 1x includes a trunk line portion 1x0 and three branch line portions 1x1 to 1x3. One end of the trunk line portion 1x0 is electrically connected to the connector 5. The branch line portions 1x1 to 1x3 are branched from the other end of the trunk line portion 1x0. The branch line portions 1x1 to 1x3 electrically connect the trunk line portion 1x0 and the detection units A (1, 1) to A (1, 3) to each other. The front-side jumper wiring layers 2x and 3x and the back-side jumper wiring layers 1y to 3y are also configured in the same manner. In this way, any single one of the front-side jumper wiring layers 1x to 3x is branched and connected to each of the front-side electrode layers 1X to 3X via the plurality of front-side contact points. Additionally, any single one of the back-side jumper wiring layers 1y to 3y is branched and connected to each of the back-side electrode layers 1Y to 3Y via the plurality of back-side contact points.

A front-side detection path that passes by way of only the front-side jumper wiring layers 1x to 3x is set between any of the detection units A (1, 1) to A (3, 3) and the connector 5. Similarly, a back-side detection path that passes by way of only the back-side jumper wiring layers 1y to 3y is set between any of the detection units A (1, 1) to A (3, 3) and the connector 5.

The sensor sheet 1 according to the present embodiment and the sensor sheet according to the first embodiment have the same function and effect for common configurations. In the sensor sheet 1 according to the present embodiment, all the detection units A (1, 1) to A (3, 3) are directly connected to the front-side jumper wiring layers 1x to 3x and the back-side jumper wiring layers 1y to 3y, respectively. Therefore, it is easy to secure the front-side detection paths and the back-side detection paths for the detection units A (1, 1) to A (3, 3) of the sensor body F even in the case where the front-side electrode layers 1X to 3X and the back-side electrode layers 1Y to 3Y are cut when the sensor body F is cut away from the sensor sheet 1.

### Third Embodiment

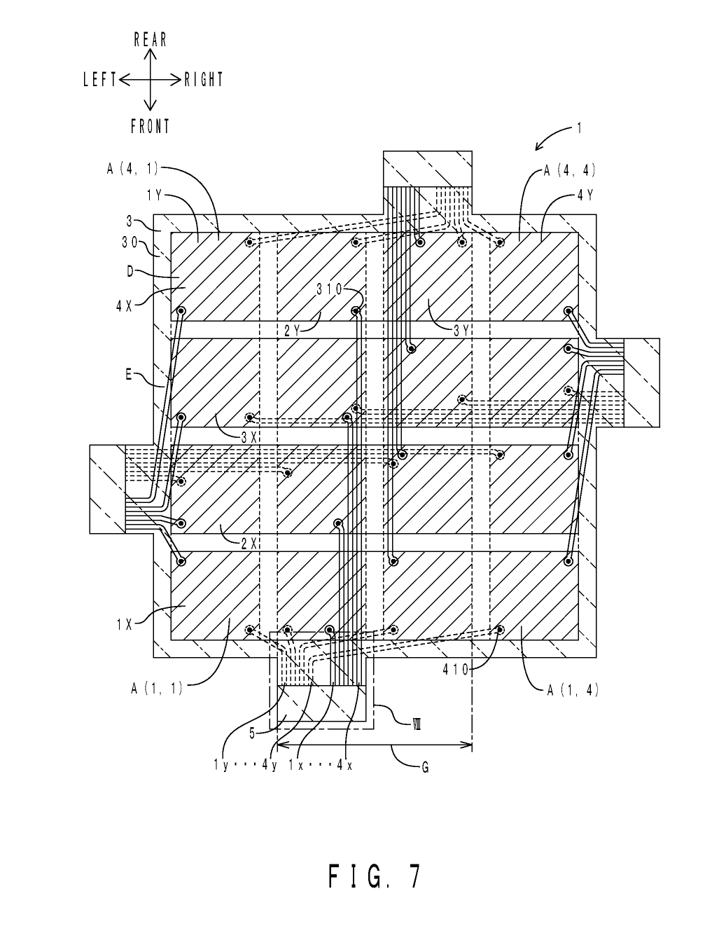

The sensor sheet according to the present embodiment differs from the sensor sheet according to the first embodiment in that the dead area includes a plurality of connectors. Only such a difference will be described below. FIG. 7 is a transparent top view of the sensor sheet according to the present embodiment. Members corresponding to those in FIG. 1 are denoted by the same reference numerals. As illustrated in FIG. 7, connectors 5 are disposed on the four sides (four edges) of the sensor sheet 1. For example, the connector 5 on the front side of the sensor sheet 1 is disposed in a section G corresponding to two detection units A (1, 2) and A (1, 3) at the middle, of the four detection units A (1, 1) to A (1, 4) which are disposed along the left-right direction (direction of extension of the front side). The remaining connectors 5 are also configured in the same manner. The plurality of connectors 5 are electrically connected to all the detection units A (1, 1) to A (4, 4).

The foremost front-side electrode layer 1X is disposed on the rear side of the connector 5 on the front side of the sensor sheet 1. A plurality of back-side contact points (black dots in the back-side through holes 410 illustrated in FIG. 7) are disposed so as to overlap the front-side electrode layer 1X as seen from the upper side. The plurality of back-side contact points are electrically connected to the connector 5 on the front side of the sensor sheet 1. The plurality of back-side contact points are disposed along the front edge (the edge that is the closer to the connector 5, i.e. the proximal edge), of the two edges of the front-side electrode layer 1X in the front-rear direction (width direction).

Similarly, the rearmost front-side electrode layer 4X is disposed on the front side of the connector 5 on the rear side of the sensor sheet 1. The plurality of back-side contact points, which are disposed so as to overlap the front-side electrode layer 4X, are electrically connected to the connector 5 on the rear side of the sensor sheet 1. The plurality of back-side contact points are disposed along the rear edge (proximal edge), of the two edges of the front-side electrode layer 4X in the front-rear direction.

Similarly, the leftmost back-side electrode layer 1Y is disposed on the right side of the connector 5 on the left side of the sensor sheet 1. The plurality of front-side contact points (black dots in the front-side through holes 310 illustrated in FIG. 7), which are disposed so as to overlap the back-side electrode layer 1Y, are electrically connected to the connector 5 on the left side of the sensor sheet 1. The plurality of front-side contact points are disposed along the left edge (proximal edge), of the two edges of the back-side electrode layer 1Y in the left-right direction (width direction).

Similarly, the rightmost back-side electrode layer 4Y is disposed on the left side of the connector 5 on the right side of the sensor sheet 1. The plurality of front-side contact points, which are disposed so as to overlap the back-side electrode layer 4Y, are electrically connected to the connector 5 on the right side of the sensor sheet 1. The plurality of front-side contact points are disposed along the right edge (proximal edge), of the two edges of the back-side electrode layer 4Y in the left-right direction.

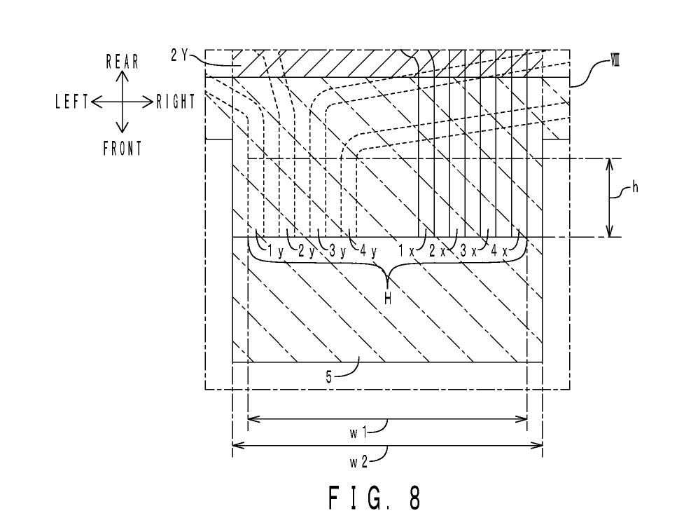

FIG. 8 is an enlarged view of the box VIII of FIG. 7. All the front-side jumper wiring layers 1x to 4x and the back-side jumper wiring layers 1y to 4y electrically connected to the connector 5 on the front side of the sensor sheet 1 are defined as a common wiring group H. The common wiring group H includes a parallel portion h. The connector 5 is disposed on the front side (one side in the direction of extension) of the parallel portion h. The back-side electrode layer 2Y is disposed on the rear side (the other side in the direction of extension) of the parallel portion h. The back-side electrode layer 2Y is included in the concept of the “reference electrode layer” according to the present invention. The back-side electrode layer 2Y extends in the front-rear direction (same direction as the direction of extension of the parallel portion h). A width w1 of the parallel portion h in the left-right direction is equal to or less than a width w2 of the back-side electrode layer 2Y in the left-right direction. Common wiring groups connected to the other connectors 5 are also configured in the same manner.

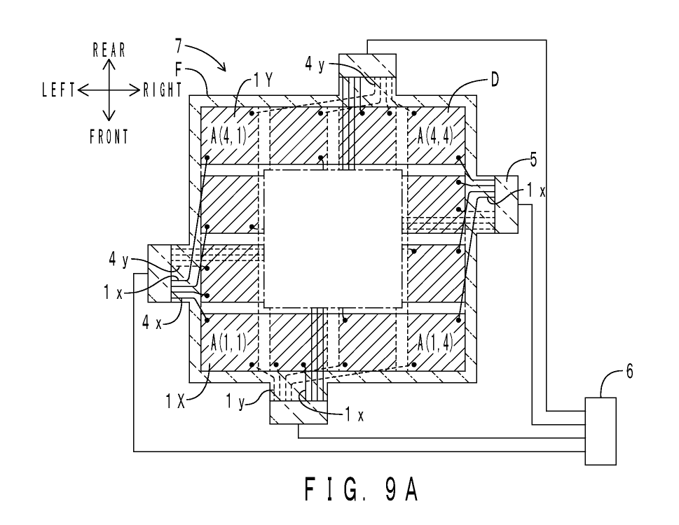

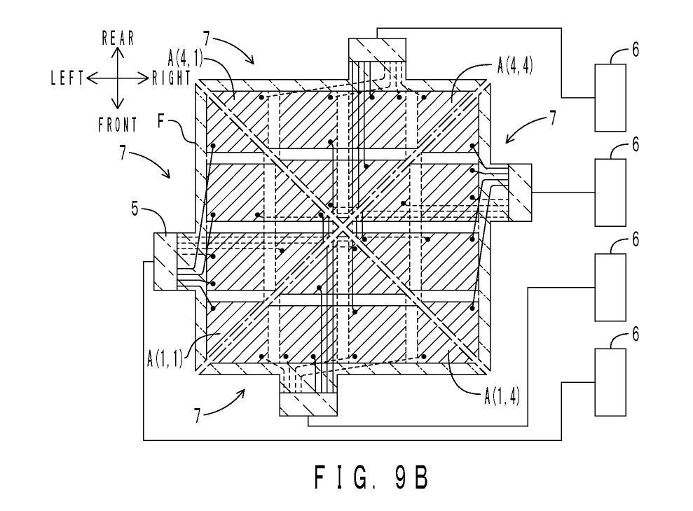

FIGS. 9A and 9B are each a transparent top view of a capacitance-type sensor that includes a sensor body (first and second) that has been cut away from the sensor sheet illustrated in FIG. 7. The front-side jumper wiring layers 1x to 4x and the front-side electrode layers 1X to 4X are indicated by the solid lines. The back-side jumper wiring layers 1y to 4y and the back-side electrode layers 1Y to 4Y are indicated by the dotted lines. The front-side contact points and the back-side contact points are indicated by the black dots.

As illustrated in FIG. 9A, the capacitance-type sensor 7 includes the sensor body F in a quadrangular shape which has been cut away from the sensor sheet 1, and the control unit 6. The sensor body F includes the detection units A (1, 1) to A (4, 4), the four connectors 5, and the front-side detection paths and the back-side detection paths for the detection units A (1, 1) to A (4, 4). The control unit 6 is electrically connected to the four connectors 5. The control unit 6 measures the load distribution in the pressure sensing area D.

When focus is placed on the detection unit A (1, 1), the detection unit A (1, 1) is electrically connected to the connector 5 on the left side of the sensor body F. Specifically, the detection unit A (1, 1) is electrically connected to the connector 5 on the left side of the sensor body F via the front-side detection path (front-side jumper wiring layer 4x) and the back-side detection path (back-side jumper wiring layer 4y and back-side electrode layer 1Y). Additionally, the detection unit A (1, 1) is electrically connected to the connector 5 on the front side of the sensor body F. Specifically, the detection unit A (1, 1) is electrically connected to the connector 5 on the front side of the sensor body F via the front-side detection path (front-side jumper wiring layer 1x and front-side electrode layer 1X) and the back-side detection path (back-side jumper wiring layer 1y). Additionally, the detection unit A (1, 1) is electrically connected to the connector 5 on the rear side of the sensor body F. Specifically, the detection unit A (1, 1) is electrically connected to the connector 5 on the rear side of the sensor body F via the back-side detection path (back-side jumper wiring layer 4y and back-side electrode layer 1Y). Additionally, the detection unit A (1, 1) is electrically connected to the connector 5 on the right side of the sensor body F. Specifically, the detection unit A (1, 1) is electrically connected to the connector 5 on the right side of the sensor body F via the front-side detection path (front-side jumper wiring layer 1x and front-side electrode layer 1X).

In this way, the single detection unit A (1, 1) is electrically connected to the plurality of connectors 5. Therefore, amounts of electricity (specifically, front-side amounts of electricity (amounts of electricity input by way of the front-side detection path) and back-side amounts of electricity (amounts of electricity input by way of the back-side detection path)) are input from the same detection unit A (1, 1) to the control unit 6 by way of the plurality of connectors 5. The control unit 6 selects one of the plurality of front-side amounts of electricity. Additionally, the control unit 6 selects one of the plurality of back-side amounts of electricity. For example, the control unit 6 selects the front-side amount of electricity and the back-side amount of electricity which are input by way of the connector 5 on the left side of the sensor body F. Alternatively, the control unit 6 selects the front-side amount of electricity and the back-side amount of electricity which are input by way of the connector 5 on the front side of the sensor body F. Alternatively, the control unit 6 selects the back-side amount of electricity which is input by way of the connector 5 on the rear side of the sensor body F and the front-side amount of electricity which is input by way of the connector 5 on the right side of the sensor body F. The control unit 6 calculates the capacitance, that is, a load, of the detection unit A (1, 1) on the basis of the front-side amount of electricity and the back-side amount of electricity which have been selected. The same process is performed also for the other detection units (each of the detection units electrically connected to the plurality of connectors 5).

As illustrated in FIG. 9B, four capacitance-type sensors 7 can be manufactured from the single sensor sheet 1. The four capacitance-type sensors 7 each include the sensor body F in a triangular shape, and the control unit 6.

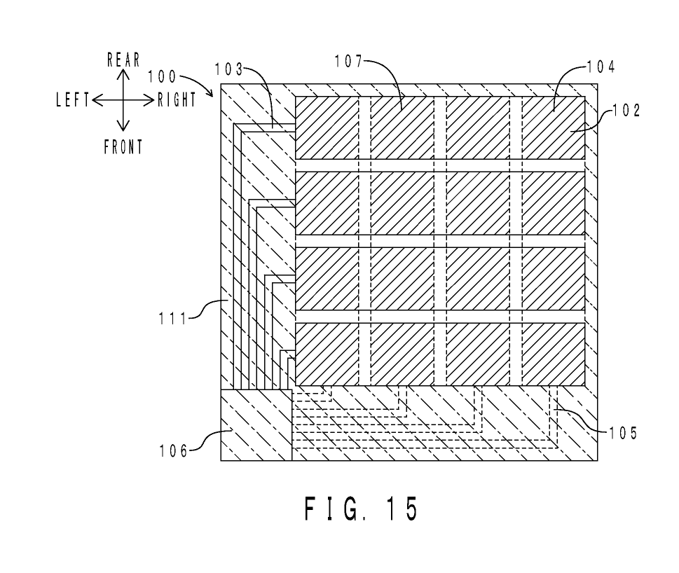

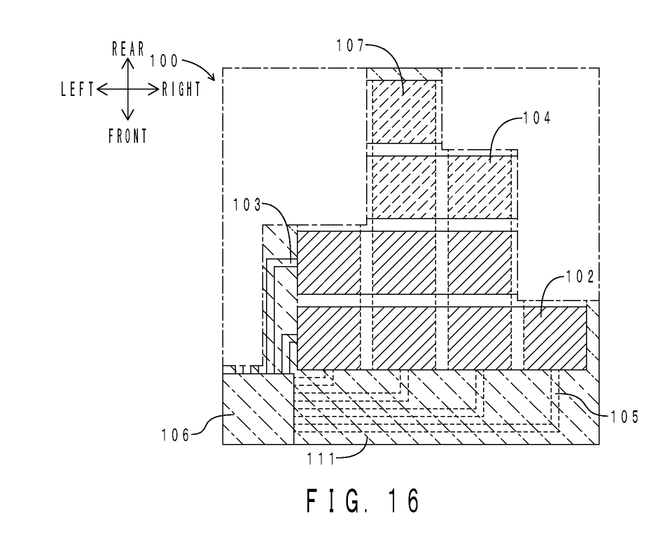

The sensor sheet 1 according to the present embodiment and the sensor sheet according to the first embodiment have the same function and effect for common configurations. A case where the capacitance-type sensor 7 illustrated in FIG. 9A is manufactured from the capacitance-type sensor 100 according to the related art illustrated in FIG. 15 is assumed. In this case, it is necessary to incorporate four cut objects (each cut away from the capacitance-type sensor 100 (see FIG. 16)) with each other so as to correspond to the four sides of the capacitance-type sensor 7 of FIG. 9A (it should be noted, however, that the incorporation method is not the related art). Therefore, a total of four capacitance-type sensors 100 are needed in order to obtain the single capacitance-type sensor 7. In this respect, as illustrated in FIG. 7, the dead area E of the sensor sheet 1 according to the present embodiment includes a plurality of connectors 5. Additionally, the plurality of connectors 5 are each electrically connected to all the detection units A (1, 1) to A (4, 4). Therefore, as illustrated in FIG. 9A, the sensor body F in a frame shape (an endless annular shape) can be cut away from the single sensor sheet 1.

In addition, as illustrated in FIG. 9B, a plurality of sensor bodies F can be cut away for each of the connectors 5 from the single sensor sheet 1. Therefore, a portion of the sensor sheet 1 to be removed (portion to be discarded) can be reduced compared to a case where the single sensor body F is cut away from the single sensor sheet 1. Thus, the manufacturing cost of the sensor body F, and hence the capacitance-type sensor 7, can be reduced.

In addition, as illustrated in FIG. 7, on the front side of the sensor sheet 1, the plurality of back-side contact points are disposed so as to overlap the front-side electrode layer 1X that is the closest to the connector 5 on the front side of the sensor sheet 1 to which the back-side contact points are electrically connected, and along the front edge (proximal edge) of the front-side electrode layer 1X, as seen from the upper side (front side) or the lower side (back side). Therefore, the degree of freedom in selecting the cut shape and the cut area of the detection units A (1, 1) to A (1, 4) when the capacitance-type sensor 7 (particularly, the capacitance-type sensor 7 which includes the connector 5 on the front side of the sensor sheet 1) is cut away is high.

Similarly, on the rear side of the sensor sheet 1, the plurality of back-side contact points are disposed so as to overlap the front-side electrode layer 4X that is the closest to the connector 5 on the rear side of the sensor sheet 1 to which the back-side contact points are electrically connected, and along the rear edge (proximal edge) of the front-side electrode layer 4X, as seen from the upper side or the lower side. Therefore, the degree of freedom in selecting the cut shape and the cut area of the detection units A (4, 1) to A (4, 4) when the capacitance-type sensor 7 (particularly, the capacitance-type sensor 7 which includes the connector 5 on the rear side of the sensor sheet 1) is cut away is high.

Similarly, on the left side of the sensor sheet 1, the plurality of front-side contact points are disposed so as to overlap the back-side electrode layer 1Y that is the closest to the connector 5 on the left side of the sensor sheet 1 to which the front-side contact points are electrically connected, and along the left edge (proximal edge) of the back-side electrode layer 1Y, as seen from the upper side or the lower side. Therefore, the degree of freedom in selecting the cut shape and the cut area of the detection units A (1, 1) to A (4, 1) when the capacitance-type sensor 7 (particularly, the capacitance-type sensor 7 which includes the connector 5 on the left side of the sensor sheet 1) is cut away is high.

Similarly, on the right side of the sensor sheet 1, the plurality of front-side contact points are disposed so as to overlap the back-side electrode layer 4Y that is the closest to the connector 5 on the right side of the sensor sheet 1 to which the front-side contact points are electrically connected, and along the right edge (proximal edge) of the back-side electrode layer 4Y, as seen from the upper side or the lower side. Therefore, the degree of freedom in selecting the cut shape and the cut area of the detection units A (1, 4) to A (4, 4) when the capacitance-type sensor 7 (particularly, the capacitance-type sensor 7 which includes the connector 5 on the right side of the sensor sheet 1) is cut away is high.

In addition, as illustrated in FIG. 8, when all the front-side jumper wiring layers 1x to 4x and the back-side jumper wiring layers 1y to 4y electrically connected to any of the connectors 5 are defined as the common wiring group H, the common wiring group H includes the parallel portion h in which all the front-side jumper wiring layers 1x to 4x and the back-side jumper wiring layers 1y to 4y are arranged in parallel with each other. The connector 5 with which the parallel portion h is continuous is disposed on one side of the parallel portion h in the direction of extension of the parallel portion h (outer side of the sensor sheet 1 in the planar direction). Additionally, a reference electrode layer 2Y that is one of the front-side electrode layers 1X to 4X or the back-side electrode layers 1Y to 4Y that extends in the same direction as the parallel portion h is disposed on the other side of the parallel portion in the direction of extension of the parallel portion h (inner side of the sensor sheet 1 in the planar direction). The width w1 of the parallel portion h is equal to or less than the width w2 of the reference electrode layer 2Y. Therefore, the parallel portion h is less likely to be broken when the capacitance-type sensor 7 (particularly, the capacitance-type sensor 7 which includes at least a part of the reference electrode layer 2Y) is cut away.

In addition, as illustrated in FIG. 7, the connector 5 on the front side of the sensor sheet 1 is disposed in the section G corresponding to two detection units A (1, 2) and A (1, 3) at the middle, of the four (even number) detection units A (1, 1) to A (1, 4) which are disposed along the left-right direction (direction of extension of the front side). Therefore, the capacitance-type sensor 7 can be freely cut away from any of the left side, the right side, and both the left and right sides of the connector 5 on the front side of the sensor sheet 1. The same applies to the other connectors 5. Thus, the degree of freedom in selecting the cut shape and the cut area of the capacitance-type sensor 7 is high.

In addition, as illustrated in FIG. 7, the front-side electrode unit 3 and the back-side electrode unit 4 have the same configuration. Specifically, the back-side electrode unit 4 is obtained by inverting the front-side electrode unit 3 in the up-down direction and rotating the front-side electrode unit 3 by 90° in a horizontal plane. Therefore, the number of parts is reduced compared to a case where the front-side electrode unit 3 and the back-side electrode unit 4 have different configurations.

### Fourth Embodiment

The sensor sheet according to the present embodiment differs from the sensor sheet according to the first embodiment in that slits are formed in the sensor sheet to fabricate the sensor body. Only such a difference will be described below.

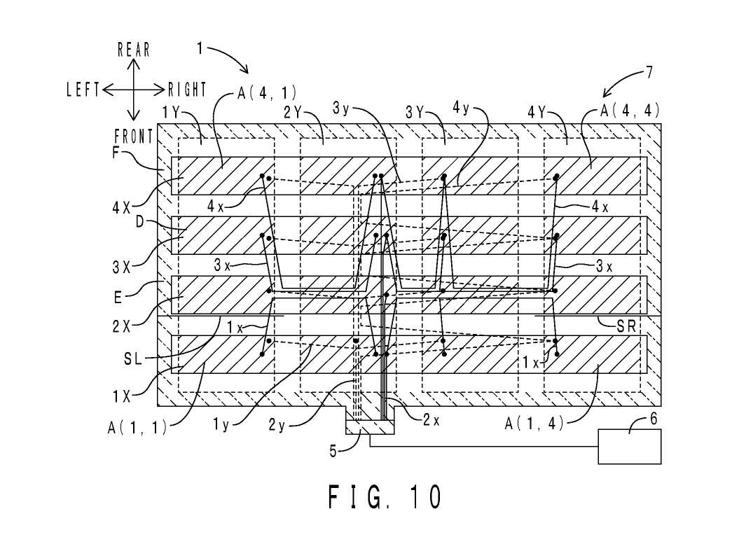

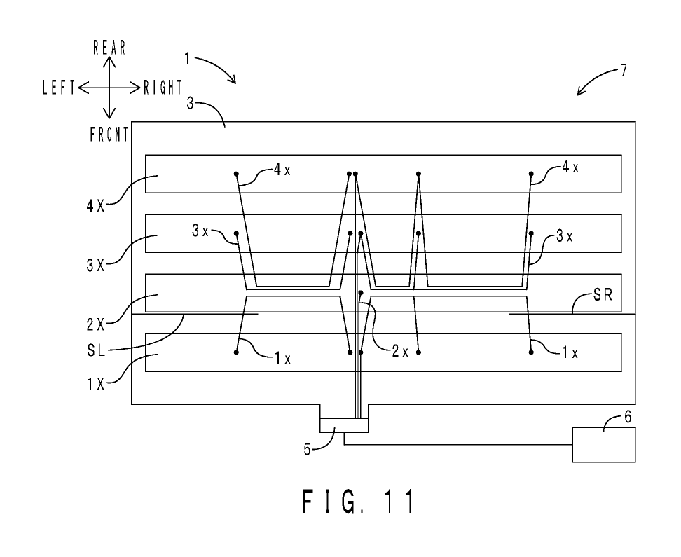

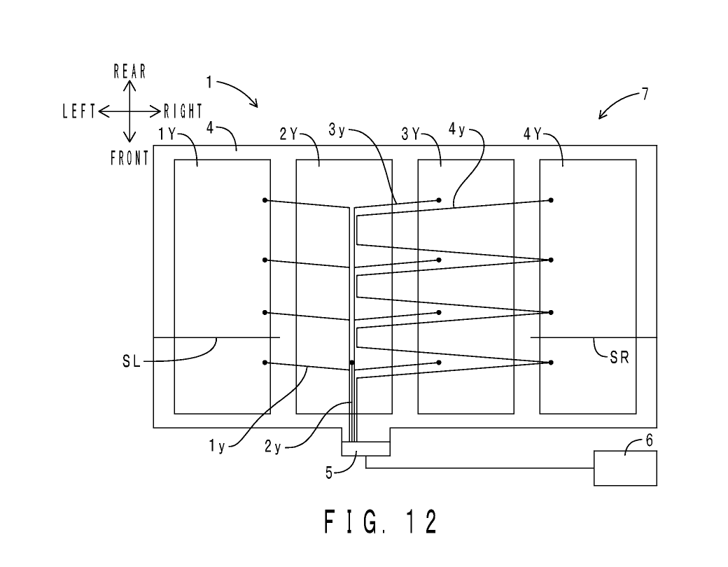

FIG. 10 is a transparent top view of the sensor sheet according to the present embodiment. FIG. 11 is a transparent top view of a front-side electrode unit of the sensor sheet. FIG. 12 is a transparent top view of a back-side electrode unit of the sensor sheet. Members corresponding to those in FIG. 1 are denoted by the same reference numerals. In addition, in FIGS. 10 to 12, the front-side contact points and the back-side contact points are indicated by the black dots. In FIG. 10, the front-side electrode layers 1X to 4X and the front-side jumper wiring layers 1x to 4x are indicated by the solid lines. The back-side electrode layers 1Y to 4Y and the back-side jumper wiring layers 1y to 4y are indicated by the dotted lines.

As illustrated in FIGS. 10 to 12, the sensor body F is the sensor sheet 1 which includes a pair of left and right slits SL and SR. The area of the sensor sheet 1 before being cut (before the slits SL and SR are formed) is equal to the area of the sensor body F after being cut (after the slits SL and SR are formed).

The slit SL is formed to extend rightward from the left side of the sensor sheet 1. The slit SL penetrates the sensor sheet 1 in the up-down direction. As illustrated in FIG. 11, the slit SL cuts the front-side jumper wiring layer 1x. As illustrated in FIG. 12, the slit SL cuts the back-side electrode layer 1Y.

Similarly, the slit SR is formed to extend leftward from the right side of the sensor sheet 1. The slit SR penetrates the sensor sheet 1 in the up-down direction. As illustrated in FIG. 11, the slit SR cuts the front-side jumper wiring layer 1x. As illustrated in FIG. 12, the slit SR cuts the back-side electrode layer 4Y.

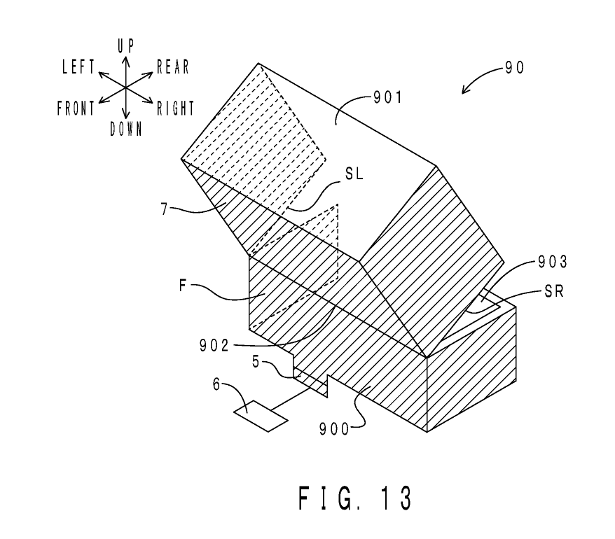

FIG. 13 illustrates the arrangement of the capacitance-type sensor according to the present embodiment. As illustrated in FIG. 13, a disposition target object 90 is a three-dimensional object. The disposition target object 90 includes a box portion 900 and a lid portion 901. The lid portion 901 can be opened/closed (swung) with respect to the box portion 900 about a hinge portion 902. As indicated by hatching in FIG. 13, the sensor body F of the capacitance-type sensor 7 is disposed on the front surface, the left surface, and the right surface of the box portion 900, and the front surface, the left surface, and the right surface of the lid portion 901. The slits SL and SR are disposed in correspondence with an opening portion 903 of the disposition target object 90.

The sensor sheet 1 according to the present embodiment and the sensor sheet according to the first embodiment have the same function and effect for common configurations. With the capacitance-type sensor 7 according to the present embodiment, conduction between all the detection units A (1, 1) to A (4, 4) and the connector 5 can be secured even if some of the jumper wiring layers and the electrode layers are cut by the slits SL and SR.

In addition, with the capacitance-type sensor 7 according to the present embodiment, as illustrated in FIG. 13, even in the case where the disposition target object 90 includes a movable portion (lid portion 901), the sensor body F can be disposed so as to follow movement of the movable portion because of the slits SL and SR. That is, the movability of the disposition target object 90 can be secured.

<Others>

The sensor sheets and the capacitance-type sensors according to the embodiments of the present invention have been described above. However, the present invention is not specifically limited to the embodiments described above. The present invention can be implemented with a variety of modifications and alterations that may be achieved by a person skilled in the art.

The shape etc. of the sensor sheet 1 illustrated in FIG. 1 is not specifically limited. In addition, the connector 5 may not be disposed in the sensor sheet 1. In this case, end portions of the front-side jumper wiring layers 1x to 4x and the back-side jumper wiring layers 1y to 4y are included in the concept of the “take-out portion” according to the present invention. In addition, a connector for the front side exclusively for the front-side jumper wiring layers 1x to 4x and a connector for the back side exclusively for the back-side jumper wiring layers 1y to 4y may be disposed separately from each other. In this case, the connector for the front side and the connector for the back side are included in the concept of the “take-out portion” according to the present invention. In addition, at least one of the front-side substrate 30, the back-side substrate 40, the front-side protection layer 32, and the back-side protection layer 42 may not be disposed in the sensor sheet 1.

The number, the shape, etc. of the front-side electrode layers 1X to 4X and the back-side electrode layers 1Y to 4Y are not specifically limited. The number of the front-side electrode layers 1X to 4X and the number of the back-side electrode layers 1Y to 4Y may be different from each other. The shape etc. of the front-side electrode layers 1X to 4X and the shape etc. of the back-side electrode layers 1Y to 4Y may be different from each other.

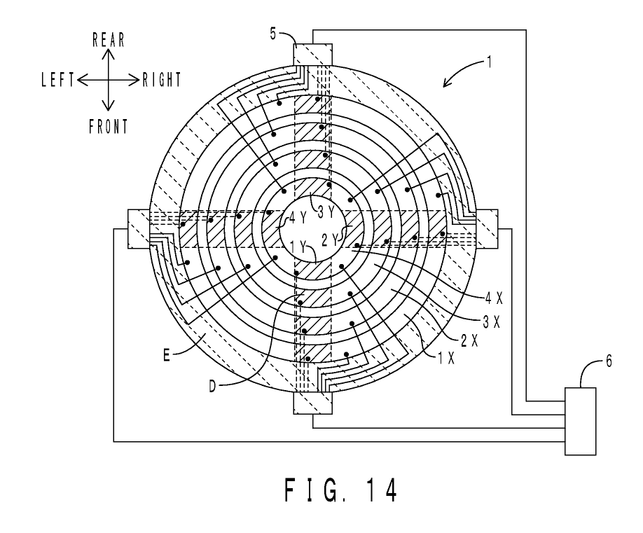

The direction of intersection between the front-side electrode layers 1X to 4X and the back-side electrode layers 1Y to 4Y is not specifically limited. FIG. 14 is a transparent top view of a sensor sheet according to another embodiment. Members corresponding to those in FIG. 1 are denoted by the same reference numerals. In addition, the front-side jumper wiring layers and the front-side electrode layers 1X to 4X are indicated by the solid lines. The back-side jumper wiring layers and the back-side electrode layers 1Y to 4Y are indicated by the dotted lines. The front-side contact points and the back-side contact points are indicated by the black dots. As illustrated in FIG. 14, the plurality of front-side electrode layers 1X to 4X each have an endless annular shape (circular shape). The front-side electrode layers 1X to 4X each extend in the circumferential direction. The front-side electrode layers 1X to 4X are disposed concentrically. The plurality of back-side electrode layers 1Y to 4Y each have a linear band shape. The back-side electrode layers 1Y to 4Y each extend in the radial direction. The back-side electrode layers 1Y to 4Y are disposed away from each other by 90° about the center of the concentric circles of the front-side electrode layers 1X to 4X. As in the present embodiment, the front-side electrode layers 1X to 4X which extend in the circumferential direction and the back-side electrode layers 1Y to 4Y which extend in the radial direction may intersect each other as seen from the upper side (front side) or the lower side (back side). In this way, the direction of intersection between the front-side electrode layers 1X to 4X and the back-side electrode layers 1Y to 4Y is not specifically limited.

Any single one of the front-side jumper wiring layers 1x to 3x may be branched and connected to the plurality of front-side electrode layers 1X to 3X.

Additionally, any single one of the back-side jumper wiring layers 1y to 3y may be branched and connected to the plurality of back-side electrode layers 1Y to 3Y.

The number, the shape, etc. of the detection units A (1, 1) to A (4, 4) are not specifically limited. A cutting line that indicates shapes into which the sensor body F can be cut (shapes into which the sensor sheet 1 can be cut while securing a front-side detection path and a back-side detection path between all the detection units A (1, 1) to A (4, 4) and the connector 5 of the sensor body F after being cut away) may be disposed on the front surface or the back surface of the sensor sheet 1. Such a cutting line occasionally separates at least one of the front-side electrode layers 1X to 4X, the front-side jumper wiring layers 1x to 4x, the back-side electrode layers 1Y to 4Y, and the back-side jumper wiring layers 1y to 4y.

As illustrated in FIGS. 5A to 5D, a trace of cutting of at least one of the front-side electrode layers 1X to 4X, the front-side jumper wiring layers 1x to 4x, the back-side electrode layers 1Y to 4Y, and the back-side jumper wiring layers 1y to 4y occasionally remains at the outer edge of the sensor body F after being cut away. It can be confirmed that the sensor body F has been cut away from the sensor sheet 1 by observing such a trace of cutting. Similarly, a trace of cutting of at least one of the dielectric layer 2, the front-side electrode unit 3, the back-side electrode unit 4, and the connector 5 occasionally remains at the outer edge of the sensor body F after being cut away. It can be confirmed that the sensor body F has been cut away from the sensor sheet 1 by observing such a trace of cutting.

The number of layers (first wiring layer 33 and second wiring layer 34) that constitute the front-side jumper wiring layers 1x to 4x is not specifically limited. There may be a single layer or three or more layers. The same also applies to the back-side jumper wiring layers 1y to 4y.

In FIG. 9A, the control unit 6 selects one of a plurality of front-side amounts of electricity and one of a plurality of back-side amounts of electricity in the case where any detection unit A (1, 1) is electrically connected to the control unit 6 by way of a plurality of connectors 5. However, a front-side amount of electricity and a back-side amount of electricity may be selected by not electrically connecting unnecessary front-side detection path and back-side detection path to the control unit. For example, unnecessary front-side detection path and back-side detection path may be broken. Alternatively, the connector 5 to which an unnecessary front-side detection path or back-side detection path is connected may not be connected to the control unit 6. Alternatively, the connector 5 to which an unnecessary front-side detection path or back-side detection path is connected may be removed from the sensor body F.

As illustrated in FIG. 7, the connector 5 on the front side of the sensor sheet 1 is disposed in the section G corresponding to two detection units A (1, 2) and A (1, 3) at the middle, of the four (an even number of) detection units A (1, 1) to A (1, 4) which are disposed along the left-right direction (direction of extension of the front side). In the case where three (an odd number of) detection units A (1, 1) to A (1, 3) are disposed along the left-right direction (direction of extension of the front side) as illustrated in FIG. 6, however, the connector 5 may be disposed in a section corresponding to the single detection unit A (1, 2) at the middle. With this configuration, the capacitance-type sensor 7 can be freely cut away from any of the left side, the right side, and both the left and right sides of the connector 5 on the front side of the sensor sheet 1 in FIG. 6.

The number of the connectors 5 which remain in the capacitance-type sensor 7 after being cut away is not specifically limited. The number of the remaining connectors 5 may be the same as the number of the connectors 5 which are disposed in the sensor sheet 1. Alternatively, only a single connector 5 may remain. In addition, the connector 5 may be partially cut when the capacitance-type sensor 7 is cut away. For example, only a portion of the connector 5 on the front side of the sensor sheet 1 illustrated in FIG. 7 to which the back-side jumper wiring layers 1y to 4y are connected may be left in the capacitance-type sensor 7. Additionally, only a portion of the connector 5 on the left side of the sensor sheet 1 to which the front-side jumper wiring layers 1x to 4x are connected may be left in the capacitance-type sensor 7. With this configuration, each of the connectors 5 can be downsized.

The number of the connectors 5 which are disposed in the single sensor sheet 1 is not specfically limited. In addition, the number of the connectors 5 which are disposed on one edge (one side) of the single sensor sheet 1 is also not specifically limited. For example, a plurality of connectors 5 may be disposed on the front side of the sensor sheet 1 illustrated in FIG. 7. In addition, the connector 5 may not be disposed on the left side of the sensor sheet 1 illustrated in FIG. 7.

In addition, each of the plurality of connectors 5 may not be electrically connected to all the detection units A (1, 1) to A (4, 4). For example, two of the four connectors 5 illustrated in FIG. 7 may be electrically connected to the detection units A (1, 1) to A (2, 4), and the remaining two connectors 5 may be electrically connected to the detection units A (3, 1) to A (4, 4).

As illustrated in FIG. 7, on the front side of the sensor sheet 1, the plurality of back-side contact points are disposed so as to overlap the front-side electrode layer 1X that is the closest to the connector 5 on the front side of the sensor sheet 1 to which the back-side contact points are electrically connected, and along the front edge (proximal edge) of the front-side electrode layer 1X, as seen from the upper side or the lower side. However, the plurality of back-side contact points may be disposed on a portion of the front-side electrode layer 1X on the front side with respect to the middle in the width direction (front-rear direction). With this configuration, a portion of the detection units A (1, 1) to A (1, 4) on the rear side with respect to the middle in the width direction can be freely cut.

Similarly, on the rear side of the sensor sheet 1, the plurality of back-side contact points are disposed so as to overlap the front-side electrode layer 4X that is the closest to the connector 5 on the rear side of the sensor sheet 1 to which the back-side contact points are electrically connected, and along the rear edge (proximal edge) of the front-side electrode layer 4X, as seen from the upper side or the lower side. However, the plurality of back-side contact points may be disposed on a portion of the front-side electrode layer 4X on the rear side with respect to the middle in the width direction (front-rear direction). With this configuration, a portion of the detection units A (4, 1) to A (4, 4) on the front side with respect to the middle in the width direction can be freely cut.

Similarly, on the left side of the sensor sheet 1, the plurality of front-side contact points are disposed so as to overlap the back-side electrode layer 1Y that is the closest to the connector 5 on the left side of the sensor sheet 1 to which the front-side contact points are electrically connected, and along the left edge (proximal edge) of the back-side electrode layer 1Y, as seen from the upper side or the lower side. However, the plurality of front-side contact points may be disposed on a portion of the back-side electrode layer 1Y on the left side with respect to the middle in the width direction (left-right direction). With this configuration, a portion of the detection units A (1, 1) to A (4, 1) on the right side with respect to the middle in the width direction can be freely cut.

Similarly, on the right side of the sensor sheet 1, the plurality of front-side contact points are disposed so as to overlap the back-side electrode layer 4Y that is the closest to the connector 5 on the right side of the sensor sheet 1 to which the front-side contact points are electrically connected, and along the right edge (proximal edge) of the back-side electrode layer 4Y, as seen from the upper side or the lower side. However, the plurality of front-side contact points may be disposed on a portion of the back-side electrode layer 4Y on the right side with respect to the middle in the width direction (left-right direction). With this configuration, a portion of the detection units A (1, 4) to A (4, 4) on the left side with respect to the middle in the width direction can be freely cut.

The number, the size, the shape, etc. of the sensor bodies F which can be cut away from the single sensor sheet 1 are not specifically limited. As illustrated in FIG. 9B, a plurality of sensor bodies F of the same size and of the same shape may be cut away from the single sensor sheet 1. Alternatively, a plurality of sensor bodies F of different sizes and of different shapes may be cut away from the single sensor sheet 1.

As illustrated in FIGS. 10 and 13, in the case where the cutting positions of the sensor sheet 1 (positions at which the slits SL and SR are formed) have been decided in advance, jumper wiring layers and electrode layers may be disposed in the sensor sheet 1 so as to avoid such cutting positions. In addition, a cuttable area (an area that secures conduction between all the detection units A (1, 1) to A (4, 4) and the connector 5 even if the sensor sheet 1 is cut in the cuttable area) may be set in the sensor sheet 1. In addition, the cuttable area may be indicated on the sensor sheet 1 using characters, figures, marks, colors, etc.

The sensor body F illustrated in FIG. 10 may be disposed on all the surfaces of the disposition target object 90 illustrated in FIG. 13. In this case, the sensor sheet 1 may be partially cut away. In this case, the sensor body F corresponds to the sensor sheet 1 which includes the slits SL and SR and the cutaway part. With this configuration, the sensor body F can be disposed easily along the three-dimensional shape of the disposition target object 90.

The slits SL and SR illustrated in FIG. 10 may be disposed on the front side and the rear side of the sensor sheet 1. In addition, the slits SL and SR may not open in the outer edge (front, rear, left, and right sides) of the sensor sheet 1. In addition, the slits SL and SR may be disposed in the upper surface and the lower surface of the sensor sheet 1. That is, slits in a groove shape (notch shape) that extend in the up-down direction may be disposed in the sensor sheet 1. With this configuration, in the case where the disposition target object 90 has an angular portion (e.g. an angular portion between the front surface and the right surface of the box portion 900), the sensor body F can be bent easily (or folded easily) along such an angular portion.

The method of forming the front-side electrode layers 1X to 4X, the front-side insulating layer 31, the front-side jumper wiring layers 1x to 4x, the front-side protection layer 32, the back-side electrode layers 1Y to 4Y, the back-side insulating layer 41, the back-side jumper wiring layers 1y to 4y, and the back-side protection layer 42 is not specifically limited. Such layers may be formed by screen printing, inkjet printing, flexographic printing, gravure printing, pad printing, lithography, a transfer method, etc.

From the viewpoint of being flexible and stretchable, the front-side electrode layers 1X to 4X, the front-side jumper wiring layers 1x to 4x, the back-side electrode layers 1Y to 4Y, and the back-side jumper wiring layers 1y to 4y are preferably configured to contain an elastomer and a conductive material. Suitable examples of the elastomer include urethane rubber, acrylic rubber, silicone rubber, ethylene-propylene copolymer rubber, natural rubber, styrene-butadiene copolymer rubber, acrylonitrile-butadiene copolymer rubber (nitrile rubber), epichlorohydrin rubber, chlorosulfonated polyethylene, and chlorinated polyethylene. The conductive material may be selected, as appropriate, from metal particles made of silver, gold, copper, nickel, rhodium, palladium, chromium, titanium, platinum, iron, alloys thereof, etc., metal oxide particles made of zinc oxide, titanium oxide, etc., metal carbide particles made of titanium carbonate etc., metal nanowires made of silver, gold, copper, platinum, nickel, etc., and conductive carbon materials such as conductive carbon black, carbon nanotubes, graphite, and graphene. These can be used singly or in a combination of two or more kinds thereof.

Suitable examples of the front-side substrate 30 and the back-side substrate 40 include resin films made of PET, polyethylene naphthalate (PEN), polyimide, polyethylene, etc., elastomer sheets, and stretchable cloths. Suitable examples of the front-side protection layer 32 and the back-side protection layer 42 include urethane rubber, acrylic rubber, silicone rubber, ethylene-propylene copolymer rubber, natural rubber, styrene-butadiene copolymer rubber, nitrile rubber, hydrogenated nitrile rubber, epichlorohydrin rubber, chlorosulfonated polyethylene, and chlorinated polyethylene in consideration of the flexibility and the permanent tensile strain.

An elastomer or a resin (including foam) with a relatively high specific dielectric constant is preferably used as the dielectric layer 2. An elastomer or a resin with a specific dielectric constant of 5 or more (measurement frequency: 100 Hz) is preferable, for example. Examples of such an elastomer include urethane rubber, silicone rubber, nitrile rubber, hydrogenated nitrile rubber, acrylic rubber, natural rubber, isoprene rubber, ethylene-propylene copolymer rubber, butyl rubber, styrene-butadiene rubber, fluorine rubber, epichlorohydrin rubber, chloroprene rubber, chlorinated polyethylene, and chlorosulfonated polyethylene. In addition, examples of such a resin include polyethylene, polypropylene, polyurethane, polystyrene (including cross-linked foamed polystyrene), polyvinyl chloride, vinylidene chloride copolymers, ethylene-vinyl acetate copolymers, and ethylene-vinyl acetate-acrylic ester copolymers. The same applies to the material of the front-side insulating layer 31 and the back-side insulating layer 41. In addition, the dielectric layer 2, the front-side insulating layer 31, and the back-side insulating layer 41 may be a gas (such as air and nitrogen), a liquid (such as oil), etc. For example, a bag filled with a gas or a liquid may be disposed as the dielectric layer 2, the front-side insulating layer 31, or the back-side insulating layer 41. In addition, the dielectric layer 2, the front-side insulating layer 31, and the back-side insulating layer 41 may be set by a plurality of support columns disposed in the planar direction to extend in the stacking direction (in other words, a gas layer secured by the support columns). With this configuration, the dielectric layer 2, the front-side insulating layer 31, and the back-side insulating layer 41 which are “solid” are not necessary.

The usage of the sensor body F which has been cut out from the sensor sheet according to the present invention is not specifically limited. For example, the sensor body F can be wrapped around a desired portion (such as an arm portion) of a robot to measure the load distribution of the wrapped portion. Alternatively, the sensor body F can be placed on the sole of a shoe as an insole sensor to measure the load distribution of a foot.

### DESCRIPTION OF THE REFERENCE NUMERALS

1 SENSOR SHEET
1X to 4X FRONT-SIDE ELECTRODE LAYER
1Y to 4Y BACK-SIDE ELECTRODE LAYER
1x to 4x FRONT-SIDE JUMPER WIRING LAYER
1x0 TRUNK LINE PORTION
1x1 to 1x3 BRANCH LINE PORTION
1y to 4y BACK-SIDE JUMPER WIRING LAYER
2 DIELECTRIC LAYER
3 FRONT-SIDE ELECTRODE UNIT
30 FRONT-SIDE SUBSTRATE
31 FRONT-SIDE INSULATING LAYER
310 FRONT-SIDE THROUGH HOLE
32 FRONT-SIDE PROTECTION LAYER
33 FIRST WIRING LAYER
34 SECOND WIRING LAYER
4 BACK-SIDE ELECTRODE UNIT
40 BACK-SIDE SUBSTRATE
41 BACK-SIDE INSULATING LAYER
410 BACK-SIDE THROUGH HOLE
42 BACK-SIDE PROTECTION LAYER
43 FIRST WIRING LAYER
44 SECOND WIRING LAYER
5 CONNECTOR (TAKE-OUT PORTION)
6 CONTROL UNIT
7 CAPACITANCE-TYPE SENSOR
90 DISPOSITION TARGET OBJECT
900 BOX PORTION
901 LID PORTION
902 HINGE PORTION
903 OPENING PORTION
A (1, 1) to A (4, 4) DETECTION UNIT
B FRONT-SIDE DETECTION PATH
C BACK-SIDE DETECTION PATH
D PRESSURE SENSING AREA
E DEAD AREA
F SENSOR BODY
H COMMON WIRING GROUP
SL SLIT
SR SLIT
h PARALLEL PORTION

1. A sensor sheet which includes:
a pressure sensing area which has a dielectric layer, a front-side electrode layer disposed on a front side of the dielectric layer, and a back-side electrode layer disposed on a back side of the dielectric layer, and in which a plurality of detection units are set at portions at which the front-side electrode layer and the back-side electrode layer overlap each other as seen from the front side or the back side; and
a dead area that is disposed adjacent to the pressure sensing area in a planar direction and that has a take-out portion that enables amounts of electricity related to capacitances of the plurality of detection units to be taken out from an outside; the sensor sheet characterized by comprising:
a front-side insulating layer that is disposed on the front side of the front-side electrode layer and that has a front-side through hole that penetrates the front-side insulating layer in a front-back direction;
a back-side insulating layer that is disposed on the back side of the back-side electrode layer and that has a back-side through hole that penetrates the back-side insulating layer in the front-back direction;
a front-side jumper wiring layer that is disposed on the front side of the front-side insulating layer and that electrically connects between the front-side electrode layer and the take-out portion via the front-side through hole; and
a back-side jumper wiring layer that is disposed on the back side of the back-side insulating layer and that electrically connects between the back-side electrode layer and the take-out portion via the back-side through hole, wherein
a front-side detection path that passes by way of at least the front-side jumper wiring layer and a back-side detection path that passes by way of at least the back-side jumper wiring layer are set between each of the plurality of detection units and the take-out portion, and
the sensor sheet is cuttable while securing a sensor body that has at least one of the detection units, the take-out portion, and the front-side detection path and the back-side detection path for the detection unit.

2. The sensor sheet according to claim 1, wherein
a plurality of the front-side electrode layers and a plurality of the back-side electrode layers extend in directions that intersect each other as seen from the front side or the back side,
contact points between the front-side jumper wiring layer and the front-side electrode layers are defined as front-side contact points, and contact points between the back-side jumper wiring layer and the back-side electrode layers are defined as back-side contact points;
the back-side contact points are disposed so as to overlap the front-side electrode layer that is the closest to the take-out portion as seen from the front side or the back side; and
the front-side contact points are disposed so as to overlap the back-side electrode layer that is the closest to the take-out portion as seen from the front side or the back side.

3. The sensor sheet according to claim 1, wherein
a contact point between the front-side jumper wiring layer and the front-side electrode layer is defined as a front-side contact point, and a contact point between the back-side jumper wiring layer and the back-side electrode layer is defined as a back-side contact point; and
the front-side contact point and the back-side contact point are disposed in all the detection units.

4. The sensor sheet according to claim 1, wherein
the dead area has a plurality of the take-out portions.

5. The sensor sheet according to claim 1, wherein
a plurality of the front-side electrode layers and a plurality of the back-side electrode layers extend in directions that intersect each other as seen from the front side or the back side,
contact points between the front-side jumper wiring layer and the front-side electrode layers are defined as front-side contact points, and contact points between the back-side jumper wiring layer and the back-side electrode layers are defined as back-side contact points;
the back-side contact points are disposed so as to overlap the front-side electrode layer that is the closest to the take-out portion to which the back-side contact points are electrically connected as seen from the front side or the back side,
one of both edges of the front-side electrode layer in a width direction, which is closer to the take-out portion, is defined as a proximal edge, and
the back-side contact points are disposed along the proximal edge.

6. The sensor sheet according to claim 1, wherein
a plurality of the front-side electrode layers and a plurality of the back-side electrode layers extend in directions that intersect each other as seen from the front side or the back side,
contact points between the front-side jumper wiring layer and the front-side electrode layers are defined as front-side contact points, and contact points between the back-side jumper wiring layer and the back-side electrode layers are defined as back-side contact points;
the front-side contact points are disposed so as to overlap the back-side electrode layer that is the closest to the take-out portion to which the front-side contact points are electrically connected as seen from the front side or the back side,
one of both edges of the back-side electrode layer in a width direction, which is closer to the take-out portion, is defined as a proximal edge, and
the front-side contact points are disposed along the proximal edge.

7. The sensor sheet according to claim 1, wherein
a plurality of the front-side electrode layers and a plurality of the back-side electrode layers extend in directions that intersect each other as seen from the front side or the back side,
all the front-side jumper wiring layer and the back-side jumper wiring layer electrically connected to any take-out portion are defined as a common wiring group,
the common wiring group has a parallel portion in which all the front-side jumper wiring layer and the back-side jumper wiring layer are arranged in parallel with each other,
the take-out portion with which the parallel portion is continuous is disposed on one side of the parallel portion in a direction of extension of the parallel portion,
a reference electrode layer that is the front-side electrode layer or the back-side electrode layer which extends in the same direction as the parallel portion is disposed on the other side of the parallel portion in the direction of extension, and
a width of the parallel portion is equal to or less than a width of the reference electrode layer.

8. The sensor sheet according to claim 1, from which the sensor body is allowed to be cut away.

9. The sensor sheet according to claim 1, wherein
the sensor body is the sensor sheet which includes a slit.

10. A capacitance-type sensor comprising:
the sensor body according to claim 8; and
a control unit electrically connected to the take-out portion.

11. The capacitance-type sensor according to claim 10, wherein
in the case where the sensor body has the detection unit which has been partially cut away, the control unit corrects the amount of electricity related to the capacitance of the detection unit.
